(19) United States
(12) Patent Application Publication
(10) Pub. No.: US 2012/0062698 A1
(43) Pub. Date: Mar. 15, 2012

(54) APPARATUS AND METHOD FOR TRANSMITTING/RECEIVING DATA IN COMMUNICATION SYSTEM

(75) Inventors: Gwang-Soon LEE, Daejeon (KR); Nam-Ho HUR, Daejeon (KR); Kug-Jin YUN, Daejeon (KR); Bong-Ho LEE, Daejeon (KR); Won-Sik CHEONG, Daejeon (KR); Hyun LEE, Daejeon (KR); Soo-In LEE, Daejeon (KR)

(73) Assignee: Electronics and Telecommunications Research Institute, Daejeon (KR)

(21) Appl. No.: 13/227,721

(22) Filed: Sep. 8, 2011

(30) Foreign Application Priority Data
Sep. 8, 2010 (KR) 10-2010-0087936
Sep. 7, 2011 (KR) 10-2011-0090927

(51) Int. Cl. H04N 13/00

(52) U.S. Cl. 348/43; 348/E13.001

(57) ABSTRACT

Disclosed is an apparatus and method for transmitting/receiving reference image data and 3D additional image data in 3D image data so as to provide a 3D image in a digital broadcasting system. In the method, a basic image and a 3D additional image in a 3D image of a 3D broadcasting service is processed in a stereoscopic image format of one of a side-by-side method and a top-down method. The basic image and the 3D additional image processed in the stereoscopic image format are encoded to a basic image stream and a 3D additional image stream. The encoded basic image stream and the encoded 3D additional image stream are multiplexed to a 3D image stream of a single stream using a dual stream method, and the multiplexed 3D image stream is then transmitted.

### CROSS-REFERENCES TO RELATED APPLICATIONS

The present application claims priority of Korean Patent Application Nos. 10-2010-0087936 and 10-2011-0090927, filed on Sep. 08, 2010 and Sep. 07, 2011, respectively, which are incorporated herein by reference in their entireties.

### BACKGROUND OF THE INVENTION

1. Field of the Invention

Exemplary embodiments of the present invention relate to a communication system; and, more particularly, to an apparatus and method for transmitting/receiving reference image data and 3D additional image data of 3D image data for providing stereoscopic image in a digital broadcasting system.

2. Description of Related Art

In current communication systems, studies have been actively conducted to provide users with services which have various qualities of service (hereinafter referred to as ‘QoS’) at a high transmission speed. In a digital broadcasting system as an example of the communication system, there are proposed plans for rapidly transmitting various types of video and audio data through limited resources. That is, in the digital broadcasting system, there are proposed many plans for improving transmission efficiency of broadcasting data containing various types of video and audio data.

In the digital broadcasting system, in order to provide users with various types of 3D digital broadcasting services of high video and audio quality, there are proposed plans for efficiently providing not only reference image data corresponding to a reference image of a 3D image in a 3D broadcasting service to be provided to the users but also 3D additional image data corresponding to a 3D additional image of the 3D image so as to provide the 3D image corresponding to demands of the users on a 3D broadcasting service.

Although demands of users who desire to receive not only 3D broadcasting services of high image quality and high quality but also various additional services are gradually increased, current digital broadcasting systems do not sufficiently satisfy these demands of the users. That is, in the current digital broadcasting systems, a plan for providing various 3D broadcasting services of high image quality and high quality, demanded by the users, i.e., a plan for transmitting/receiving 3D image data corresponding to the 3D broadcasting service has not been proposed so far. Particularly, a plan for transmitting/receiving 3D image data so as to provide a 3D broadcasting service has recently been proposed, but in the digital broadcasting systems do not satisfy demands of users on 3D broadcasting services of high image quality and high quality.

Therefore, in order to stably provide a 3D broadcasting service of high image quality and high quality, demanded by users, in a communication system, i.e., a digital broadcasting system, it is required to propose a plan for transmitting/receiving 3D image data corresponding to a 3D image in the 3D broadcasting service, i.e., reference image data corresponding to a reference image in the 3D image and 3D additional image data corresponding to a 3D additional image in the 3D image.

### SUMMARY OF THE INVENTION

An embodiment of the present invention is directed to an apparatus and method for transmitting/receiving data in a communication system.

Another embodiment of the present invention is directed to an apparatus and method for transmitting/receiving 3D image data in a communication system.

Another embodiment of the present invention is directed to an apparatus and method for transmitting/receiving reference image data corresponding to a reference image in a 3D image of 3D broadcasting service and a 3D additional image data corresponding to a 3D additional image in the 3D image so that a digital broadcasting system provides the 3D broadcasting service in a communication system.

Another embodiment of the present invention is directed to an apparatus and method for transmitting/receiving 3D image data so that a digital broadcasting system of a dual stream method provides users with a 3D broadcasting service in a stereoscopic image format of a side-by-side method or top-down method in a communication system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for transmitting data in a communication system includes an image format processing unit configured to process a basic image and a 3D additional image in a 3D image of a 3D broadcasting service in a stereoscopic image format; a first encoder configured to encode basic image data corresponding to the basic image processed in the stereoscopic image format; a second encoder configured to encode 3D additional image data corresponding to the 3D additional image processed in the stereoscopic image format; and a multiplexing unit configured to multiplex the encoded basic image data and the encoded 3D additional image data to 3D image data of a single stream and transmit the multiplexed 3D image data.

In accordance with another embodiment of the present invention, an apparatus for receiving data in a communication system includes a demultiplexing unit configured to receive 3D image data of a single stream, corresponding to a 3D image of a 3D broadcasting service, and demultiplex the received 3D image data to basic image data corresponding to a basic image in the 3D image and 3D additional image data corresponding to a 3D additional image in the 3D image; a first decoder configured to decode the basic image data; a second decoder configured to decode the 3D additional image data; and an image rendering unit configured to restore a basic image in a stereoscopic image format in the decoded basic image data to the basic image in the 3D image, and restore a 3D addition image in the stereoscopic image format in the decoded basic image data to the 3D additional image in the 3D image.

In accordance with another embodiment of the present invention, a method for transmitting data in a communication system includes processing a basic image and a 3D additional image in a 3D image of a 3D broadcasting service in a stereoscopic image format of one of a side-by-side method and a top-down method; encoding the basic image and the 3D additional image processed in the stereoscopic image format to a basic image stream and a 3D additional image stream; and multiplexing the encoded basic image stream and the encoded 3D additional image stream to a 3D image stream of a single stream using a dual stream method, and transmitting the multiplexed 3D image stream.

In accordance with another embodiment of the present invention, a method for receiving data in a communication system includes receiving 3D image data of a single stream, corresponding to a 3D broadcasting service, and demultiplexing the received 3D image data to a basic image in a 3D image and a 3D additional image in the 3D image using a dual stream method; decoding the demultiplexed basic image and the demultiplexed 3D additional image; and restoring the decoded basic image and the decoded 3D additional image to the 3D image of the 3D broadcasting service in a stereoscopic image format of one of a side-by-side method and a top-down method and providing the 3D image of the 3D broadcasting service.

### BRIEF DESCRIPTION OF THE DRAWINGS

FIGS. 1 and 2 schematically illustrate stereoscopic image formats in a digital broadcasting system of a communication system in accordance with an embodiment of the present invention.

FIG. 3 schematically illustrates a structure of a digital broadcasting system in a communication system in accordance with an embodiment of the present invention.

FIGS. 4 to 7 schematically illustrate stereoscopic image formats in a digital broadcasting system of a communication system in accordance with an embodiment of the present invention.

FIG. 8 schematically illustrates a structure of a digital broadcasting system in a communication system in accordance with an embodiment of the present invention.

FIG. 9 is a flowchart schematically illustrating an operation of a transmitting apparatus in a communication system in accordance with an embodiment of the present invention.

FIG. 10 is a flowchart schematically illustrating an operation of a receiving apparatus in a communication system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes a communication system, e.g., an apparatus and method for transmitting/receiving data, which provides a 3D broadcasting service in a digital broadcasting system. In embodiments of the present invention, there is proposed an apparatus and method for transmitting/receiving 3D image data so that a digital broadcasting system provides users with a 3D broadcasting service of high image quality and high quality, demanded by the users, in a communication system. In the embodiments of the present invention, a reference image data corresponding to a reference image in a 3D image of the 3D broadcasting service and a 3D additional image data corresponding to a 3D additional image in the 3D image of the 3D broadcasting service are transmitted/received in the digital broadcasting system.

In the embodiment of the present invention, a reference image data corresponding to a reference image in a 3D image of a 3D broadcasting service and a 3D additional image data corresponding to a 3D additional image in the 3D image of the 3D broadcasting service are transmitted/received so as to provide users with the 3D broadcasting service of high image quality and high quality in a stereoscopic image format of a side-by-side method or top-down method in a digital broadcasting system for providing the 3D broadcasting service using a stereoscopic image of a dual stream method. That is, in the embodiments of the present invention, the reference image data and the 3D additional image data are transmitted/received so that the digital broadcasting system provides the reference image and 3D additional image of the 3D image in the stereoscopic image format of the side-by-side method or top-down method.

In the embodiments of the present invention, the digital broadcasting system provides a 3D broadcasting service using a stereoscopic image. Particularly, the digital broadcasting system a 3D digital image service as a 3D broadcasting service to an apparatus for receiving the 3D broadcasting service, which supports a stereoscopic image format of a side-by-side method or top-down method, through a 3D digital broadcasting system of a dual stream method. In the embodiments of the present invention, the digital broadcasting system provides not only left/right original images in the 3D image of the 3D broadcasting service but also stereoscopic image contents of the side-by-side method or top-down method through the 3D digital broadcasting system of the dual stream method. Particularly, the digital broadcasting system effectively provides a 3D broadcasting service of high image quality and high quality to users of a 3D broadcasting receiving terminal that supports the side-by-side method or top-down method.

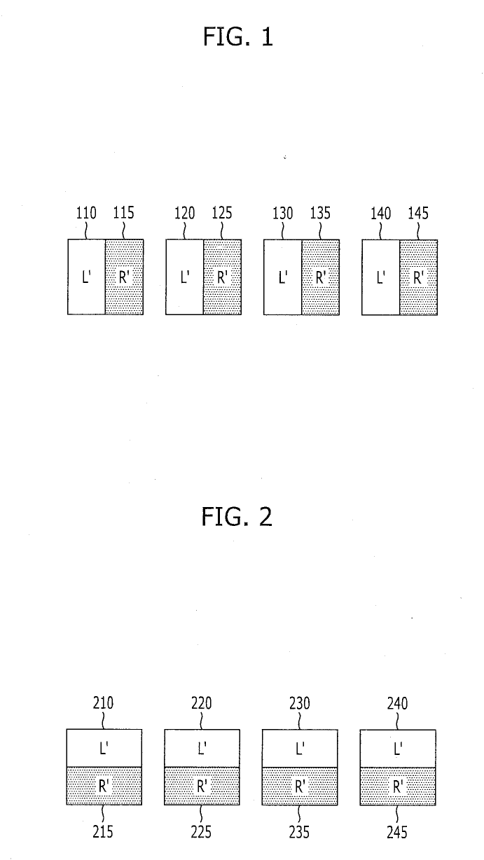

In the embodiments of the present invention, the 3D broadcasting service is provided to the apparatus for receiving the 3D broadcasting service, which supports the side-by-side method or top-down method, through the 3D digital broadcasting system of the dual stream method, so that the apparatus for receiving the 3D broadcasting service can provide users not only with the 3D broadcasting service of existing quality but also with the dual stream method by receiving the stereoscopic image of the side-by-side method or top-down method. Accordingly, it is possible to provide a 3D broadcasting service of high image quality and high quality. Hereinafter, stereoscopic image formats for a 3D broadcasting service in a digital broadcasting system of a communication system in accordance with an embodiment of the present invention will be described in detail with reference to FIGS. 1 and 2.

FIGS. 1 and 2 schematically illustrate stereoscopic image formats in a digital broadcasting system of a communication system in accordance with an embodiment of the present invention. Here, FIG. 1 schematically illustrates a stereoscopic image format of the side-by-side method in the digital broadcasting system, and FIG. 2 schematically illustrates a stereoscopic image format of the top-down method in the digital broadcasting system.

As illustrated in FIG. 1, the stereoscopic image format of the side-by-side method is shown as an image obtained by horizontally decimating a left image L in a 3D image, e.g., a left image L′ 110, 120, 130 or 140 which is decimated to ½ of the left image L, and an image obtained by horizontally decimating a right image R in the 3D image, e.g., a right image R′ 115, 125, 135 or 145 which is decimated to ½ of the right image R.

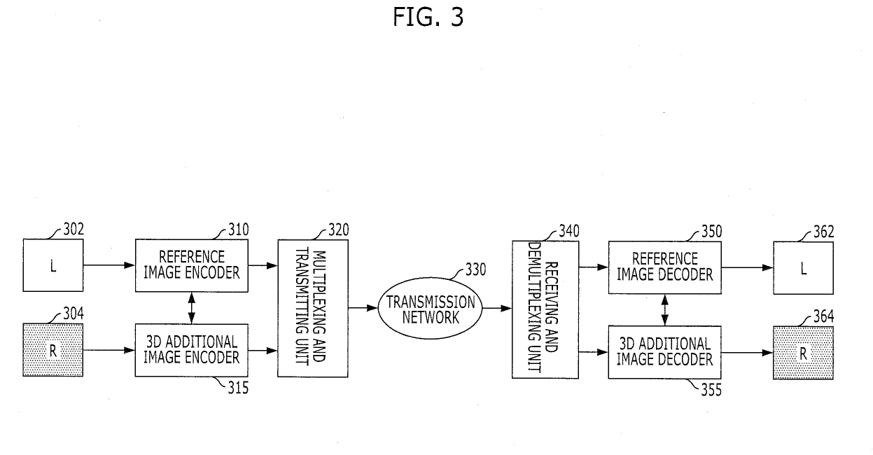

As illustrated in FIG. 2, the stereoscopic image format of the top-down method shows an image obtained by vertically decimating a left image L in a 3D image, e.g., a left image L′ 210, 220, 230 or 240 which is decimated to ½ of the left image L, and an image obtained by vertically decimating a right image R in the 3D image, e.g., a right image R′ 215, 225, 235 or 245 which is decimated to ½ of the right image R. Hereinafter, a digital broadcasting system in a communication system in accordance with an embodiment of the present invention will be described in detail with reference to FIG. 3.

FIG. 3 schematically illustrates a structure of a digital broadcasting system in a communication system in accordance with an embodiment of the present invention. Here, FIG. 3 schematically illustrates the structure of a digital broadcasting system of a dual stream method.

Referring to FIG. 3, the digital broadcasting system includes a reference image encoder 310, a 3D additional image encoder 315, a multiplexing and transmitting unit 320, a receiving and demultiplexing unit 340, a reference image decoder 350 and a 3D additional image decoder 355. The reference image encoder 310 encodes reference image data corresponding to a reference image in a left image L 302 and a right image R 304 in a 3D image. The 3D additional image encoder 315 encodes 3D additional image data corresponding to a 3D additional image in the left image L 302 and the right image R 304 in the 3D image. The multiplexing and transmitting unit 320 multiplexes the encoded reference image data and the 3D additional image data as 3D image data and then transmits the 3D image data through a transmission network 330. The receiving and demultiplexing unit 340 receives the 3D image data through the transmission network 330 and demultiplexer the received 3D image data to the reference image data and the 3D additional image data. The reference image decoder 350 decodes the demultiplexed reference image data. The 3D additional image decoder 355 decodes the demultiplexed 3D additional image data.

Here, the reference image decoder 350 and the 3D additional image decoder 355 decode the demultiplexed reference image data and the demultiplexed 3D additional image data, respectively, and provide users with a left image 362 and a right image 364 in a 3D image. The reference image in the 3D image means an image compatible with a general 2D image, e.g., a left or right image. The 3D additional image in the 3D image means an image making a pair together with the reference image so as to constitute a stereoscopic image. The 3D additional image is an image corresponding to the reference image, e.g., a right image when the reference image is a left image or a depth or disparity image corresponding to the reference image.

The digital broadcasting system includes a transmitting apparatus including the reference image encoder 310, the 3D additional image encoder 315 and the multiplexing and transmitting unit 320, and a receiving apparatus including the receiving and demultiplexing unit 340, the reference image decoder 350 and the 3D additional image decoder 355.

In order to provide a 3D broadcasting service, the reference image encoder 310 of the transmitting apparatus encodes basic image data corresponding to a basic image of the left and right images 302 and 304 in the 3D image of the 3D broadcasting service. The 3D additional image encoder 315 of the transmitting apparatus encodes 3D additional image data corresponding to a 3D additional image of the left and right images 302 and 304 in the 3D image of the 3D broadcasting service.

Here, the reference image encoder 310 and the 3D additional image encoder 315 independently or interactively encode the respective left and right images in the stereoscopic image format using the dual stream method, and output dual image streams, i.e., a basic image data stream and a 3D additional image data stream, respectively. The reference image encoder 310 is a general video encoder for encoding a reference image in a 3D image, and the 3D additional image encoder 315 is a video encoder for independently encoding a 3D additional image in the 3D image or encoding the 3D additional image by interacting with the reference image encoder 310.

The multiplexing and transmitting unit 320 of the transmitting apparatus multiplexes the reference image data stream and the 3D additional image data stream, respectively outputted from the reference image encoder 310 and the 3D additional image encoder 315, to a single stream, and performs channel encoding and modulation processes of the multiplexed single stream. Then, the multiplexing and transmitting unit 320 transmits the single stream through the transmission network 330. Here, the multiplexing and transmitting unit 320 multiplexes the encoded basic image data and the encoded 3D additional image data to single 3D image data, and the 3D image data is transmitted to the receiving apparatus through the transmission network 330.

The receiving and demultiplexing unit 340 of the receiving apparatus receives a 3D broadcasting signal, i.e., 3D image data, transmitted through the transmission network 330, and performs demodulation, channel decoding and demultiplexing processes of the received 3D image data. Then, the receiving and demultiplexing unit 340 outputs a reference image data stream and a 3D additional data stream. That is, the receiving and demultiplexing unit 340 demultiplexes the received 3D image data and outputs reference image data corresponding to a reference image in a 3D image and 3D additional image data corresponding to a 3D additional image in the 3D image.

The reference image decoder 350 and the 3D additional image decoder 355 in the receiving apparatus decode the basic image data and the 3D additional image data, respectively, and the left and right images 362 and 364 in the 3D image, i.e., a 3D image is displayed, thereby providing a 3D broadcasting service to users. Here, the reference image decoder 350 and the 3D additional image decoder 355 perform independent decoding or interactive decoding. That is, the 3D additional image decoder 355 independently decodes the 3D additional image in the 3D image or decodes the 3D additional image in the 3D image by interacting with the reference image decoder 350.

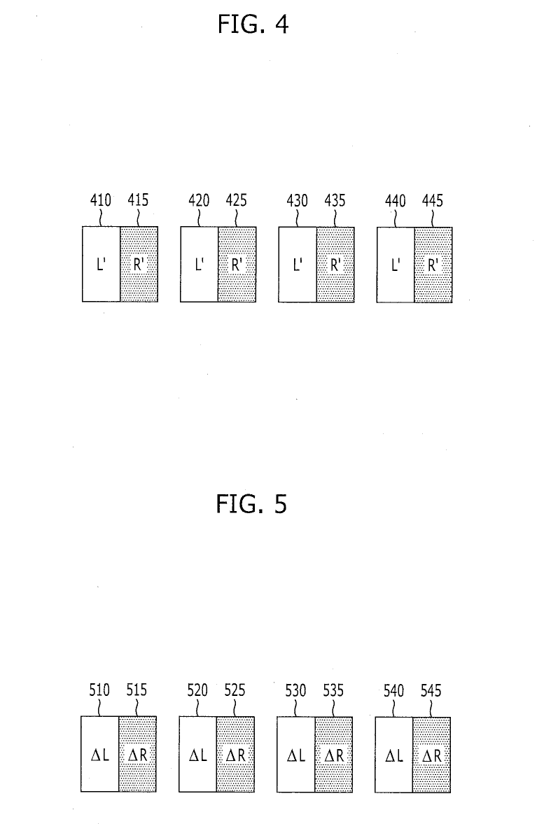

In the digital broadcasting system of the dual stream method in accordance with the embodiment of the present invention, for example, a 2D terminal in the receiving apparatus decodes a basic image stream, i.e., the basic image data so as to stably constitute a general image screen, thereby ensure inverse compatibility with a 2D image system. The digital broadcasting system encodes the left and right images 302 and 340 to left and right images L′ and R′ in the stereoscopic image format, horizontally or vertically decimated to ½ of the respective left and right images 302 and 304, using the side-by-side method or top-down method described in FIGS. 1 and 2, and then transmits the encoded left and right images. The digital broadcasting system provides a 3D image by decoding the left and right images L′ and R′ in the stereoscopic image format, encoded and transmitted as described above. Hereinafter, stereoscopic image formats for providing a 3D broadcasting service in a digital broadcasting system of a communication system in accordance with an embodiment of the present invention will be described in detail with reference to FIGS. 4 to 7.

FIGS. 4 to 7 schematically illustrate stereoscopic image formats in a digital broadcasting system of a communication system in accordance with an embodiment of the present invention. FIG. 4 schematically illustrates a reference image in the stereoscopic image formation of the side-by-side method in the digital broadcasting system. FIG. 5 schematically illustrates a 3D additional image in the stereoscopic image format of the side-by-side method in the digital broadcasting system. FIG. 6 schematically illustrates a reference image in the stereoscopic image formation of the top-down method in the digital broadcasting system. FIG. 7 schematically illustrates a 3D additional image in the stereoscopic image format of the top-down method in the digital broadcasting system.

As illustrated in FIG. 4, the basic image in the stereoscopic image format of the side-by-side method is shown as an image obtained by horizontally decimating a left image L in a 3D image, e.g., a left image L′ 410, 420, 430 or 440 decimated to ½ of the left image L, and an image obtained by horizontally decimating a right image R in the 3D image, e.g., a right image R′ 415, 425, 435 or 445 decimated to ½ of the right image R.

As illustrated in FIG. 5, the 3D additional image in the stereoscopic image format of the side-by-side method is shown as an image obtained by horizontally decimating a left image L in a 3D image, e.g., a left image L′ decimated to ½ of the left image L and a left image difference ΔL 510, 520, 530 or 540 between the left images L, and an image obtained by horizontally decimating a right image R in the 3D image, e.g., a right image R′ decimated to ½ of the right image R and a right image difference ΔR 515, 525, 535 or 545 between the right images R.

Here, the 3D additional image is composed of auxiliary image information in the reference image of the side-by-side method as illustrated in FIG. 4. More specifically, the 3D additional image is composed of auxiliary image information for minimizing the deterioration of the quality of the left and right images L and R generated when the decimated left image L′ 410, 420, 430 or 440 and the decimated right image R′ 415, 425, 435 or 445 are interpolated in the receiving apparatus so as to be restored as the left and right images L and R with the original size.

In other words, the 3D additional image illustrated in FIG. 5 is composed of information obtained by decimating difference information between the left original image, i.e., the left image L in the basic image and the interpolation image obtained by interpolating the decimated left image L′ 410, 420, 430 or 440 illustrated in FIG. 4 to have the size of the left original image and information obtained by decimating difference information between the right original image, i.e., the right image R in the basic image and the interpolation image obtained by interpolating the decimated right image R′ 415, 425, 435 or 445 illustrated in FIG. 4 to have the size of the left original image. That is, the left image difference ΔL 510, 520, 530 or 540 included in the 3D additional image includes auxiliary image information obtained by decimating difference information between the decimated left image L′ 410, 420, 430 or 440 and the interpolation image of the decimated left image L′ 410, 420, 430 and 440. The right image difference ΔR 515, 525, 535 or 545 included in the 3D additional image includes auxiliary image information obtained by decimating difference information between the decimated right image R′ 415, 425, 435 or 445 and the interpolation image of the decimated right image R′ 415, 425, 435 and 445.

Here, the left image difference ΔL 510, 520, 530 or 540 means horizontal decimation of a difference in horizontal interpolation (L—horizontal interpolation L′) between the left original image L and the decimated left image L′ 410, 420, 430 or 440, and the right image difference ΔL 515, 525, 535 or 545 means horizontal decimation of a difference in horizontal interpolation (R—horizontal interpolation R′) between the right original image R and the decimated right image R′ 415, 425, 435 or 445. The horizontal interpolation L′ or R′ means a process of performing restoration by enlarging the left or right image L′ or R′ subjected to horizontal decimation filtering to ½ of the size of the left or right image L or R so as to have the original size through interpolation filtering. The horizontal decimation ΔL or ΔR means a process of horizontally decimating and filtering a corresponding left or right image to have a ½ of its size. Accordingly, the left image difference ΔL means a left image obtained by horizontally decimating the difference between the left original image and the horizontally interpolated left image, and the right image difference ΔR means a right image obtained by horizontally decimating the difference between the right original image and the horizontally interpolated right image.

In the stereoscopic image format of the side-by-side method illustrated in FIG. 4, the basic image is shown as the left image L′ 410, 420, 430 and 440 decimated by sub-sampling an odd-numbered or even-numbered pixel of the left image L in the horizontal decimation of the left image L and the right image R′ 415, 425, 435 and 445 decimated by sub-sampling an odd-numbered or even-numbered pixel of the right image R in the horizontal decimation of the right image R. In the stereoscopic image format of the side-by-side method illustrated in FIG. 5, the 3D additional image is shown as the left image difference ΔL 510, 520, 530 or 540 decimated by sub-sampling an even-numbered or odd-numbered pixel of the left image in the horizontal decimation of the difference horizontal interpolation (L—horizontal interpolation L′) between the left original image L and the decimated left image L′ 410, 420, 430 or 440 and the right image difference ΔR 515, 525, 535 or 545 decimated by sub-sampling an even-numbered or odd-numbered pixel of the right image in the horizontal decimation of the difference horizontal interpolation (R—horizontal interpolation R′) between the right original image R and the decimated right image R′ 415, 425, 435 or 445.

In a case where the decimated left image L′ 410, 420, 430 or 440 is an image decimated by sub-sampling the odd-numbered pixel, the decimated left image difference ΔL 510, 520, 530 or 540 is an image decimated by sub-sampling the even-numbered pixel. In a case where the decimated right image R′ 415, 425, 435 or 445 is an image decimated by sub-sampling the odd-numbered pixel, the decimated right image difference ΔL 515, 525, 535 or 545 is an image decimated by sub-sampling the even-numbered pixel. On the contrary, in a case where the decimated left image L′ 410, 420, 430 or 440 is an image decimated by sub-sampling the even-numbered pixel, the decimated left image difference ΔL 510, 520, 530 or 540 is an image decimated by sub-sampling the odd-numbered pixel. In a case where the decimated right image R′ 415, 425, 435 or 445 is an image decimated by sub-sampling the even-numbered pixel, the decimated right image difference ΔL 515, 525, 535 or 545 is an image decimated by sub-sampling the odd-numbered pixel.

The stereoscopic image format is configured by alternately sub-sampling the decimated left image L′ 410, 420, 430 or 440 and decimated right image R′ 415, 425, 435 or 445 and the decimated left image difference ΔL 510, 520, 530 or 540 and decimated right image difference ΔL 515, 525, 535 or 545. Accordingly, in a case where a reference image and a 3D additional image in a 3D image are interpolated, the receiving apparatus minimize the deterioration of the quality of an image generated in the decimation and interpolation of the reference image and the 3D additional image by alternately interleaving an odd-numbered or even-numbered pixel of the reference image and an even-numbered or odd-numbered pixel of the 3D additional image and then processing the 3D image. As described above, the 3D additional image is an image corresponding to the reference image, e.g., a right image when the reference image is a left image or a depth or disparity image corresponding to the reference image. That is, the decimated left image difference ΔL 510, 520, 530 or 540 and the decimated right image difference ΔL 515, 525, 535 or 545 include auxiliary image information such as depth or disparity information.

Next, the stereoscopic image format of the top-down method in the digital broadcasting system will be described in detail with reference to FIGS. 6 and 7. As illustrated in FIG. 6, in the stereoscopic image format of the top-down method, the basic image is shown as an image obtained by vertically decimating a left image L in a 3D image, e.g., a left image L′ 610, 620, 630 or 640 decimated to ½ of the left image L and an image obtained by vertically decimating a right image R in the 3D image, e.g., a right image R′ 615, 625, 635 or 645 decimated to ½ of the right image R.

As illustrated in FIG. 7, in the stereoscopic image format of the top-down method, the 3D additional image is shown as a left image difference ΔL 610, 620, 630 or 640 between the left image L and the image obtained by vertically decimating the left image L in the 3D image, e.g., the left image L′ decimated to ½ of the left image L and a right image difference ΔR 615, 625, 635 or 645 between the right image R and the image obtained by vertically decimating the right image R in the 3D image, e.g., the right image R′ decimated to ½ of the right image R.

Here, the 3D additional image is composed of auxiliary image information in the reference image of the top-down method as illustrated in FIG. 6. More specifically, the 3D additional image is composed of auxiliary image information for minimizing the deterioration of the quality of the left and right images L and R generated when the decimated left image L′ 610, 620, 630 or 640 and the decimated right image R′ 615, 625, 635 or 645 are interpolated in the receiving apparatus so as to be restored as the left and right images L and R with the original size.

In other words, the 3D additional image illustrated in FIG. 7 is composed of information obtained by decimating difference information between the left original image, i.e., the left image L in the basic image and the interpolation image obtained by interpolating the decimated left image L′ 610, 620, 630 or 640 illustrated in FIG. 6 to have the size of the left original image and information obtained by decimating difference information between the right original image, i.e., the right image R in the basic image and the interpolation image obtained by interpolating the decimated right image R′ 615, 625, 635 or 645 illustrated in FIG. 6 to have the size of the left original image. That is, the left image difference ΔL 710, 720, 730 or 740 included in the 3D additional image includes auxiliary image information obtained by decimating difference information between the decimated left image L′ 610, 620, 630 or 640 and the interpolation image of the decimated left image L′ 610, 620, 630 and 640. The right image difference ΔR 715, 725, 735 or 745 included in the 3D additional image includes auxiliary image information obtained by decimating difference information between the decimated right image R′ 615, 625, 635 or 645 and the interpolation image of the decimated right image R′ 615, 625, 635 and 645.

Here, the basic image of the top-down method illustrated in FIG. 6, i.e., the decimated left image L′ 610, 620, 630 or 640 and the decimated right image R′ 615, 625, 635 or 645, means an image obtained through vertical decimation, unlike the basic image of the side-by-side method illustrated in FIG. 4, i.e., the horizontal decimation in the decimated left image L′ 410, 420, 430 or 440 and the decimated right image R′ 415, 425, 435 or 445. The 3D additional image of the top-down method illustrated in FIG. 7, i.e., the left image difference ΔL 710, 720, 730 or 740 and the right image difference ΔR 715, 725, 735 or 745, means an image obtained through vertical interpolation and vertical decimation, unlike the 3D additional image of the side-by-side method illustrated in FIG. 5, i.e., the horizontal interpolation and horizontal decimation in the left image difference ΔL 510, 520, 530 or 540 and the right image difference ΔR 515, 525, 535 or 545.

In this case, the vertical interpolation L′ or R′ means a process of performing restoration by enlarging the left or right image L′ or R′ decimated and filtered to ½ of the size of the left or right image L or R to have the original size through interpolation filtering. The vertical decimation ΔL or ΔR means a process of vertically decimating and filtering a corresponding left or right image to have a ½ of its size. Accordingly, the left image difference ΔL means a left image obtained by vertically decimating the difference between the left original image and the vertically interpolated left image, and the right image difference ΔR means a right image obtained by vertically decimating the difference between the right original image and the vertically interpolated right image.

In the stereoscopic image format of the top-down method illustrated in FIGS. 6 and 7, the basic image and the 3D additional image in the 3D image are shown as images decimated by sub-sampling odd-numbered or even-numbered pixels, like the basic image and the 3D additional image in the 3D image of the side-by-side method illustrated in FIGS. 4 and 5. The images decimated by sub-sampling the even-numbered or odd-numbered pixels have been described in the basic image and the 3D additional image in the 3D image of the side-by-side method, and therefore, their detailed descriptions will be omitted.

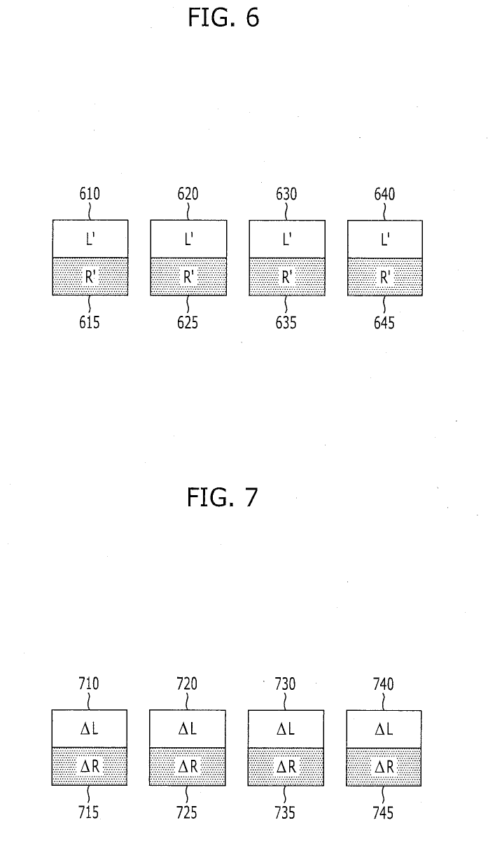

That is, in the stereoscopic image format of the top-down method illustrated in FIGS. 6 and 7, the basic image and the 3D additional image are identical to those of the side-by-side method illustrated in FIGS. 4 and 5 in that the basic image and the 3D additional image are images obtained through the vertical decimation and vertical interpolation, unlike the horizontal decimation and horizontal interpolation in the basic image and the 3D additional image in the 3D image of the side-by-side method. As described above, the 3D additional image is an image corresponding to the reference image, e.g., a right image when the reference image is a left image or a depth or disparity image corresponding to the reference image. That is, the decimated left image difference ΔL 710, 720, 730 or 740 and the decimated right image difference ΔL 715, 725, 735 or 745, illustrated in FIG. 7, include auxiliary image information such as depth or disparity information. Hereinafter, a digital broadcasting system in a communication system in accordance with an embodiment of the present invention will be described in detail with reference to FIG. 8.

FIG. 8 schematically illustrates a structure of a digital broadcasting system in a communication system in accordance with an embodiment of the present invention. Here, FIG. 8 schematically illustrated the structure of a digital broadcasting system of a dual stream method.

Referring to FIG. 8, the digital broadcasting system includes a 3D image format processing unit 810, a reference image encoder 820, a 3D additional image encoder 825, a multiplexing and transmitting unit 830, a receiving and demultiplexing unit 850, a reference image decoder 860, a 3D additional image decoder 865 and a 3D image rendering unit 870. The 3D image format processing unit 810 processes reference images and 3D additional images of a left image L 802 and a right image R 804 in a 3D image in the stereoscopic image format of the side-by-side method or top-down method illustrated in FIGS. 4 to 7. The reference image encoder 820 encodes reference image data corresponding to reference images 812 and 814 processed in the stereoscopic image format of the side-by-side method or top-down method. The 3D additional image encoder 825 encodes 3D additional image data corresponding to 3D additional images 816 and 818 processed in the stereoscopic image format of the side-by-side method or top-down method. The multiplexing and transmitting unit 830 multiplexes the encoded reference image data and the encoded 3D additional image data to 3D image data and then transmits the 3D image data through a transmission network 840. The receiving and demultiplexing unit 850 receives the 3D image data through the transmission network 840 and demultiplexes the received 3D image data to reference image data and 3D additional image data. The reference image decoder 860 decodes the demultiplexed reference image data. The 3D additional image decoder 865 decodes the demultiplexed 3D image data. The 3D image rendering unit 870 restores reference images 872 and 874 of the decoded reference image data and 3D additional images 876 and 878 of the decoded 3D additional image data and provides users with a left image L 882 and a right image R 884 in a 3D image.

Here, the reference image in the 3D image means an image compatible with a general 2D image, e.g., a left or right image. The 3D additional image in the 3D image means an image making a pair together with the reference image so as to constitute a stereoscopic image. The 3D additional image is an image corresponding to the reference image, e.g., a right image when the reference image is a left image or a depth or disparity image corresponding to the reference image.

The digital broadcasting system includes a transmitting apparatus including the 3D image format processing unit 810, the reference image encoder 820, the 3D additional image encoder 825 and the multiplexing and transmitting unit 830, and a receiving apparatus including the receiving and demultiplexing unit 850, the reference image decoder 860, the 3D additional image decoder 865 and the 3D image rendering unit 870.

In order to provided a 3D broadcasting service, the 3D image format processing unit 810 of the transmitting apparatus processes basic images and 3D additional images of the left and right images 802 and 804 in the 3D image of the 3D broadcasting service in the stereoscopic image format of the side-by-side method or top-down method as described in FIGS. 4 to 7. That is, the basic images and 3D additional images of the left and right images 802 and 804 may be shown as described in FIGS. 4 to 7 by the 3D image format processing unit 810. Here, the basic image and the 3D additional image shown in the stereoscopic image format of the side-by-side method or top-down method by the 3D image format processing unit 810 have been specifically described in FIGS. 4 to 7, and therefore, their detailed descriptions will be omitted. For convenience of illustration in FIG. 8, it will be mainly described that the 3D image format processing unit 810 outputs the basic images 812 and 814 and the 3D additional images 816 and 818 in the stereoscopic image formation of the side-by-side method.

The basic image data corresponding to the basic image processed in the stereoscopic image format of the side-by-side method or top-down method illustrated in FIGS. 4 to 7 by the 3D image format processing unit 810 as described above is outputted to the reference image encoder 820, and the 3D additional image data corresponding to the 3D additional image is outputted to the 3D additional image encoder 830.

The reference image encoder 820 of the transmitting apparatus encodes the basic image data of the basic image processed in the stereoscopic image format of the side-by-side method or top-down method. The 3D additional image encoder 825 of the transmitting apparatus encodes the 3D additional image data of the 3D additional image processed in the stereoscopic image format of the side-by-side method or top-down method.

Here, the reference image encoder 820 and the 3D additional image encoder 825 independently or interactively encode the respective left and right images in the stereoscopic image format using the dual stream method, and output dual image streams, i.e., a basic image data stream and a 3D additional image data stream, respectively. The reference image encoder 820 is a general video encoder for encoding a reference image in a 3D image, and the 3D additional image encoder 825 is a video encoder for independently encoding a 3D additional image in the 3D image or encoding the 3D additional image by interacting with the reference image encoder 820.

The multiplexing and transmitting unit 830 of the transmitting apparatus multiplexes the reference image data stream and the 3D additional image data stream, respectively outputted from the reference image encoder 820 and the 3D additional image encoder 825, to a single stream, and performs channel encoding and modulation processes of the multiplexed single stream. Then, the multiplexing and transmitting unit 830 transmits the single stream through the transmission network 840. Here, the multiplexing and transmitting unit 830 multiplexes the encoded basic image data and the encoded 3D additional image data to single 3D image data, and the 3D image data is transmitted to the receiving apparatus through the transmission network 840.

The receiving and demultiplexing unit 850 of the receiving apparatus receives a 3D broadcasting signal, i.e., 3D image data, transmitted through the transmission network 840, and performs demodulation, channel decoding and demultiplexing processes of the received 3D image data. Then, the receiving and demultiplexing unit 850 outputs a reference image data stream and a 3D additional data stream. That is, the receiving and demultiplexing unit 850 demultiplexes the received 3D image data and outputs reference image data corresponding to a reference image in a 3D image and 3D additional image data corresponding to a 3D additional image in the 3D image.

The reference image decoder 860 and the 3D additional image decoder 865 in the receiving apparatus decode the basic image data and the 3D additional image data, respectively, and output the reference images 872 and 874 of the decoded reference image data and the 3D additional images 876 and 878 of the decoded 3D additional image data to the 3D image rendering unit 870. Here, the reference image decoder 860 and the 3D additional image decoder 865 perform independent decoding or interactive decoding. That is, the 3D additional image decoder 865 independently decodes the 3D additional image in the 3D image or decodes the 3D additional image in the 3D image by interacting with the reference image decoder 860.

The 3D image rendering unit 870 of the receiving apparatus restores the left image L 882 and the right image R 884 in the 3D image by rendering the reference images 872 and 874 of the decoded reference image data and the 3D additional images 876 and 878 of the decoded 3D additional image data. That is, in a case where the transmitting apparatus in the 3D broadcasting system of the dual stream method processes a basic image and a 3D additional image in a 3D image in the stereoscopic image formation of the side-by-side method or top-down method and transmits the processed basic image and 3D additional image as described above, the 3D image rendering unit 870 provides users with a 3D image of a 3D broadcasting service by processing the received reference image and 3D additional image and respectively reproducing images to have sizes of the left and right original images.

Here, the 3D image rendering unit 870 enlarges a reference image and a 3D additional image in the stereoscopic image format of the side-by-side method or top-down method to left and right images with original sizes through horizontal or vertical interpolation and then combines auxiliary image information of the basic image corresponding to the 3D additional image with the enlarged left and right images, i.e., the basic image, thereby providing users with a 3D image with minimized deterioration of image quality, i.e., a high image quality and high quality 3D image.

More specifically, the 3D image rendering unit 870 enlarges left and right images L′ and R′ horizontally decimated or vertically decimated as described in FIGS. 4 to 7 to have the sizes of left and right original images through the horizontal or vertical interpolation, by performing a process opposite to that of horizontal decimation or vertical decimation of the left and right images L and R, performed by the 3D image format processing unit 810, in the stereoscopic image format of the side-by-side method or top-down method illustrated in FIGS. 4 to 7. The 3D image rendering unit 870 enlarges image differences between the left and right original images and the interpolated left and right images to have the sizes of the left and right original images by performing horizontal or vertical interpolation on left and right image differences ΔL and ΔR horizontally or vertically decimated as described in FIGS. 4 to 7. The 3D image rendering unit 870 outputs the left and right images 882 and 884, i.e., provides users with the high image quality and high quality 3D image by combining the enlarged and interpolated left and right image differences (interpolation ΔL and interpolation ΔR) with the left and right images (interpolation L′ and interpolation R′) enlarged and interpolated to have the sizes of the left and right original images.

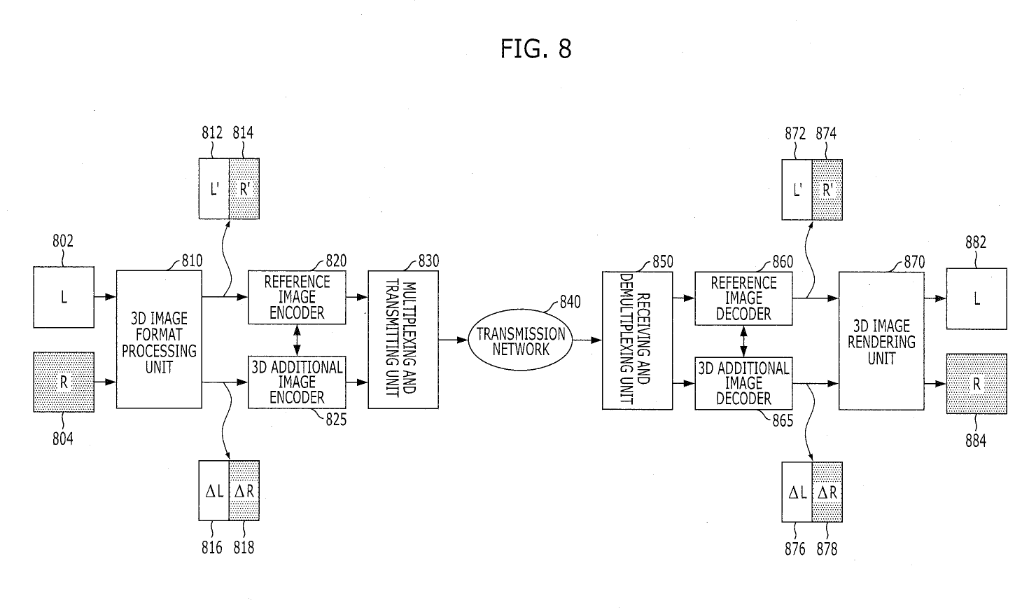

In the digital broadcasting system of a dual stream method in accordance with the embodiment of the present invention, the transmitting apparatus processes a reference image and a 3D additional image in a 3D image in the stereoscopic image format of the side-by-side method or top-down method into a 3D image of the dual stream method and then transmits the processed 3D image. The receiving apparatus restores the reference image and the 3D additional image in the 3D image by processing the 3D image transmitted from the transmitting apparatus into a 3D image of the dual stream method. Accordingly, the high image quality and high quality 3D broadcasting service is provided to the users. Hereinafter, data transmission of a digital broadcasting system in a communication system in accordance with an embodiment of the present invention will be described in detail with reference to FIG. 9.

FIG. 9 is a flowchart schematically illustrating an operation of a transmitting apparatus in a communication system in accordance with an embodiment of the present invention.

Referring to FIG. 9, at step 910, the transmitting apparatus receives 3D image data corresponding to a 3D image of a 3D broadcasting service to be provided to users. That is, the transmitting apparatus receives basic image data corresponding to a basic image in the 3D image and 3D additional image data corresponding to a 3D additional image in the 3D image.

At step 920, the transmitting apparatus performs a format process on the 3D image data, i.e., processes the basic image and the 3D additional image in the 3D image in the stereoscopic image formation of the side-by-side method or top-down method as described above. Here, the processing of the basic image and the 3D additional image in the stereoscopic image formation of the side-by-side method or top-down method has been specifically described with reference to FIGS. 4 to 7, and therefore, its detailed description will be omitted.

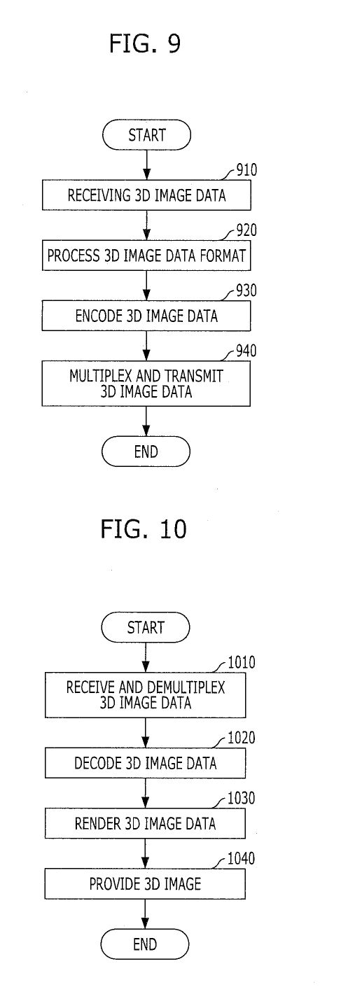

At step 930, the transmitting apparatus encodes the 3D image data processed in the stereoscopic image format. At step 940, the transmitting apparatus multiplexes the encoded 3D image data and then transmits the multiplexed 3D image data through a transmission network. Here, the transmitting apparatus encodes the basic image and the 3D additional image in the stereoscopic image format to a basic image data stream and a 3D additional image data stream using the dual stream method, and multiplexes the basic image data stream and the 3D additional image data stream, encoded as described above, to a single stream, i.e., a 3D image data stream. Hereinafter, data reception of a digital broadcasting system in a communication system in accordance with an embodiment of the present invention will be described in detail with reference to FIG. 10.

FIG. 10 is a flowchart schematically illustrating an operation of a receiving apparatus in a communication system in accordance with an embodiment of the present invention.

Referring to FIG. 10, at step 1010, the receiving apparatus receives the 3D image data transmitted from the transmitting apparatus in the digital broadcasting system through the transmission network, and demultiplexes the received 3D image data to basic image data and 3D additional image data. Here, the receiving apparatus demultiplexes the 3D image data corresponding to the 3D image of the dual stream method to the basic image data corresponding to the basic image in the 3D image and the 3D additional image data corresponding to the 3D additional image in the 3D image. That is, the receiving apparatus demultiplexes a single 3D image data stream to a basic image data stream and a 3D additional image data stream using the dual stream method.

At step 1020, the receiving apparatus decodes the demultiplexed 3D image data, i.e., the basic image data and the 3D additional image data. At step 1030, the receiving apparatus restores the decoded 3D image data to the 3D image, i.e., renders a reference image of the decoded reference image data and a 3D additional image of the decoded 3D additional image data. Here, the receiving apparatus interpolates the reference image of the decoded reference image and interpolates the 3D additional image of the decoded 3D additional image data, thereby enlarging the interpolated reference image and the interpolated 3D additional image into left and right original images. The rendering of the reference image and the 3D additional image, i.e., the rendering of the reference image and the 3D additional image has been specifically described with reference to FIG. 8, and therefore, its detailed description will be omitted.

At step 1040, the receiving apparatus provides the left and right images, i.e., provides the 3D image to users, thereby providing a high image quality and high quality 3D broadcasting service. Here, the receiving apparatus processes the basic image and the 3D additional image in the 3D image using the dual stream method, and provides the high image quality and high quality 3D broadcasting service through the rendering of the 3D image at the step 1030.

In accordance with the exemplary embodiments of the present invention, in a communication system, a digital broadcasting system of a dual stream method transmits/receives a reference image and a 3D additional image in a 3D image in a stereoscopic image format of a side-by-side method or top-down method, so that left and right reference images in the 3D image and left and right 3D additional images in the 3D image can be provided to users, thereby stably providing a high image quality and high quality 3D broadcasting service to the users.

While the present invention has been described with respect to the specific embodiments, it will be apparent to those skilled in the art that various changes and modifications may be made without departing from the spirit and scope of the invention as defined in the following claims.

What is claimed is:

1. An apparatus for transmitting data in a communication system, the apparatus comprising:
an image format processing unit configured to process a basic image and a 3D additional image in a 3D image of a 3D broadcasting service in a stereoscopic image format;
a first encoder configured to encode basic image data corresponding to the basic image processed in the stereoscopic image format;
a second encoder configured to encode 3D additional image data corresponding to the 3D additional image processed in the stereoscopic image format; and
a multiplexing unit configured to multiplex the encoded basic image data and the encoded 3D additional image data to 3D image data of a single stream and transmit the multiplexed 3D image data.

2. The apparatus of claim 1, wherein the image format processing unit processes the basic image and the 3D additional image in a stereoscopic image format of one of a side-by-side method and a top-down method.

3. The apparatus of claim 2, wherein the image format processing unit horizontally decimates left and right images in the basic image, and outputs the decimated left and right images as the basic image in the stereoscopic image format.

4. The apparatus of claim 3, wherein the image format processing unit horizontally decimates a left image difference between the left image and a left image obtained by horizontally interpolating the decimated left image and a right image difference between the right image and a right image obtained by horizontally interpolating the decimated right image, and outputs the decimated left image difference and the decimated right image difference as a 3D additional image in the stereoscopic image format.

5. The apparatus of claim 4, wherein the image format processing unit horizontally decimates the images through horizontal decimation filtering, and horizontally interpolates the images through interpolation filtering.

6. The apparatus of claim 4, wherein the image format processing unit outputs the decimated left image and the decimated right image as the basic image in the stereoscopic image format by sub-sampling odd-numbered or even-numbered pixels of the decimated left image and the decimated right image, and outputs the decimated left image difference and the decimated right image difference as the 3D additional image in the stereoscopic image format by sub-sampling even-numbered or odd-numbered pixels of the decimated left image difference and the decimated right image difference.

7. The apparatus of claim 2, wherein the image format processing unit vertically decimates the left and right images in the basic image, and outputs the decimated left and right images as the basic image in the stereoscopic image format.

8. The apparatus of claim 7, wherein the image format processing unit vertically decimates a left image difference between the left image and a left image obtained by vertically interpolating the decimated left image and a right image difference between the right image and a right image obtained by vertically interpolating the decimated right image, and outputs the decimated left image difference and the decimated right image difference as a 3D additional image in the stereoscopic image format.

9. The apparatus of claim 8, wherein the image format processing unit vertically decimates the images through vertical decimation filtering, and vertically interpolates the images through interpolation filtering.

10. The apparatus of claim 8, wherein the image format processing unit outputs the decimated left image and the decimated right image as the basic image in the stereoscopic image format by sub-sampling odd-numbered or even-numbered pixels of the decimated left image and the decimated right image, and outputs the decimated left image difference and the decimated right image difference as the 3D additional image in the stereoscopic image format by sub-sampling even-numbered or odd-numbered pixels of the decimated left image difference and the decimated right image difference.

11. The apparatus of claim 2, wherein the 3D additional image is one of a right image corresponding to the basic image, a depth image and a disparity image.

12. An apparatus for receiving data in a communication system, the apparatus comprising:
a demultiplexing unit configured to receive 3D image data of a single stream, corresponding to a 3D image of a 3D broadcasting service, and demultiplex the received 3D image data to basic image data corresponding to a basic image in the 3D image and 3D additional image data corresponding to a 3D additional image in the 3D image;
a first decoder configured to decode the basic image data;
a second decoder configured to decode the 3D additional image data; and
an image rendering unit configured to restore a basic image in a stereoscopic image format in the decoded basic image data to the basic image in the 3D image, and restore a 3D addition image in the stereoscopic image format in the decoded basic image data to the 3D additional image in the 3D image.

13. The apparatus of claim 12, wherein the basic image and the 3D additional image in the stereoscopic image format are images obtained by decimating the basic image and the 3D additional image in the 3D image in a stereoscopic image format of one of a side-by-side method and a top-down method.

14. The apparatus of claim 13, wherein the image rendering unit restores left and right images decimated in the basic image in the 3D image to the basic image in the 3D image through horizontally interpolating, restores left and right images decimated in the 3D additional image in the 3D image to the 3D additional image in the 3D image through horizontally interpolating, and provides the 3D image of the 3D broadcasting service by combining the restored 3D additional image with the restored basic image.

15. The apparatus of claim 13, wherein the image rendering unit restores left and right images decimated in the basic image in the 3D image to the basic image in the 3D image through vertically interpolating, restores left and right images decimated in the 3D additional image in the 3D image to the 3D additional image in the 3D image through vertically interpolating, and provides the 3D image of the 3D broadcasting service by combining the restored 3D additional image with the restored basic image.

16. The apparatus of claim 13, wherein the 3D additional image is one of a right image corresponding to the basic image, a depth image and a disparity image.

17. A method for transmitting data in a communication system, the method comprising:
processing a basic image and a 3D additional image in a 3D image of a 3D broadcasting service in a stereoscopic image format of one of a side-by-side method and a top-down method;
encoding the basic image and the 3D additional image processed in the stereoscopic image format to a basic image stream and a 3D additional image stream; and
multiplexing the encoded basic image stream and the encoded 3D additional image stream to a 3D image stream of a single stream using a dual stream method, and transmitting the multiplexed 3D image stream.

18. The method of claim 17, wherein said processing of the basic image and the 3D additional image in the 3D image in the stereoscopic image format horizontally or vertically decimates left and right images in the basic image, and horizontally or vertically interpolates a left image difference between the left image and a left image obtained by horizontally or vertically interpolating the decimated left image and a right image difference between the right image and a right image obtained by horizontally or vertically interpolating the decimated right image.

19. A method for receiving data in a communication system, the method comprising:
receiving 3D image data of a single stream, corresponding to a 3D broadcasting service, and demultiplexing the received 3D image data to a basic image in a 3D image and a 3D additional image in the 3D image using a dual stream method;
decoding the demultiplexed basic image and the demultiplexed 3D additional image; and
restoring the decoded basic image and the decoded 3D additional image to the 3D image of the 3D broadcasting service in a stereoscopic image format of one of a side-by-side method and a top-down method and providing the 3D image of the 3D broadcasting service.

20. The method of claim 19, wherein said providing of the 3D image restores the left and right images of the basic image in the 3D image, decimated in the stereoscopic image format, to the basic image in the 3D image through horizontally or vertically interpolating, restores the left and right image differences of the 3D additional image in the 3D image, decimated in the stereoscopic image format, to the 3D additional image in the 3D image through horizontally or vertically interpolating, and providing the 3D image of the 3D broadcasting service by combining the restored 3D additional image with the restored basic image.
